(19) United States
(12) Patent Application Publication
(10) Pub. No.: US 2020/0134539 A1
(43) Pub. Date: Apr. 30, 2020

(54) TIME, ACTIVITY AND PERSONNEL TRACKER

(71) Applicant: C2P Group Corp., Brooklyn, NY (US)

(72) Inventors: Yitzchok Furth, Brooklyn, NY (US); Shimon Smilowitz, Brooklyn, NY (US)

(21) Appl. No.: 16/662,640

(22) Filed: Oct. 24, 2019

Related U.S. Application Data
(60) Provisional application No. 62/749,773, filed on Oct. 24, 2018.

(51) Int. Cl. G06Q 10/06; G06Q 10/10; H04W 4/029; H04W 4/80

(52) U.S. Cl. CPC G06Q 10/063114; G06Q 10/06398; G06Q 10/06316; H04W 4/80; G06Q 10/1097; G06Q 10/063116; H04W 4/029; G06Q 10/06393

(57) ABSTRACT

A time, activity and personnel tracking (TAPT) system includes work stations, each configured to perform thereat a plurality of tasks respectively associated with one or more of a plurality of projects, the tasks being associated with and assigned to be performed by one or more persons. A plurality of personal identification devices (PID) are configured to be worn or carried by said persons and each said PID uniquely identifying a respective one of said persons. A plurality of proximity sensors (PXS), each being mounted to or located at a given one of said work stations, are configured to detect the presence of a given one of said persons adjacent thereto, by sensing the PID worn or carried by that person, when said given person has located himself or herself within a predetermined distance to said PXS. A task/project electronic recording (TR) board displays at the work stations a list of tasks assigned to the person, for selection by the person a task to be performed. Lastly, a time tracking (TT) software module is configured to track and record the amounts of time spent by the person on the selected task.

### CROSS-REFERENCE TO RELATED APPLICATION

The present non-provisional patent application claims the benefit of and priority to U.S. Provisional Patent Application No. 62/749,773, filed Oct. 24, 2018, by Yitzchok Furth and Shimon Smilowitz, and entitled “TIME, ACTIVITY AND PERSONNEL TRACKER,” the entire content of which is incorporated herein by reference.

### BACKGROUND OF THE INVENTION

The present application generally relates to a computerized method and system for time and project tracking and, more particularly, to a system and method that not only tracks projects and tasks, but also tracks employees who are tasked with performing various functions and assignments on the various projects and tasks.

Prior art methods and systems for tracking and reporting time spent on tasks are described in United States Patent Publications: US 2017/0178042, US 2013/0346506, US 2007/0143169, US 2006/0277544, US 2003/0204367, US 2002/0128803, US 2002/0116266 and US 2001/0003172. The full contents of the aforementioned United States Patent Publications contents are incorporated by reference herein.

It is often necessary or desirable to keep track of the time spent by individuals while performing a task. Nowhere is this truer than in the business world, where fees are often based in whole or in part by the amount of time spent by individuals in performing tasks on behalf of a customer or client. For example, professionals such as attorneys and accountants often bill their clients based on the number of hours worked on behalf of their clients. As another example, government contracts often specify that contractors will be paid based on the number of hours spent by people such as engineers and the like while working on a project such as designing or maintaining a system.

The United States Patent and Trademark Office is itself utilizing a system for tracking various projects and tasks that are assigned to individual patent examiners who are working away from the central office location of the United States Patent and Trademark Office.

In general, there are still drawbacks in the prior art relative to tracking of projects, tasks and employees. The present invention aims to provide a system and method that ameliorates substantially all of the drawbacks in the prior art relative to the tracking of projects, tasks and employees.

### SUMMARY OF THE INVENTION

Accordingly, it is an object of the present invention to provide a system and method for tracking projects, tasks and employees that is implemented substantially through the use of software with a minimum amount of physical hardware associated therewith.

The foregoing and other objects of the invention are realized with a system that in accordance with preferred embodiments thereof comprises a time, activity and personnel tracking (TAPT) system that comprises: a plurality of work stations, each configured to perform thereat a plurality of tasks respectively associated with one or more of a plurality of projects, said tasks being associated with and assigned to be performed by one or more persons; a plurality of personal identification devices (PID) configured to be worn or carried by said persons and each said PID uniquely identifying a respective one of said persons; a plurality of proximity sensors (PXS), each said PXS being mounted to or located at a given one of said work stations, and being configured to detect the presence of a given one of said persons adjacent thereto, by sensing the PID worn or carried by that person, when said given person has located himself or herself within a predetermined distance to said PXS; a task/project electronic recording (TR) board displayable at said work stations and configured to present said persons with a list of tasks assigned to said person, for selection by said person of a task to be performed; and a time tracking (TT) software module configured to track and record the amounts of time spent by said person on said selected task while at said work station.

Preferably, the TR board being further configured to display to said person a total hours parameter that designates a total number of hours that has been allocated to said tasks. The TR board may be further configured to display to said person a total hours spent parameter that designates the number of hours already spent by said person on said task. The TR board is preferably further configured to display to said person a total hours percentage parameter that designates a percentage of an allocated budget that has already been utilized on a given project.

Preferably, the PID is configured to be detected by said PXS utilizing near frequency communications (NFC). Or, the PID is configured to be detected by the PXS utilizing Bluetooth. A camera system may be included as well as associated software that is configured to recognize a face of a person located at a computer and to match that face to only one of a plurality of faces stored in a database associated with said system, thereby to recognize and identify a person located at said work station. Preferably, a log-on software module is included that is configured to enable a person to log-on a selected one of said work stations by one of operating a keyboard on said work station and by pressing an icon on a screen associated with said work station.

Preferably, the system includes a managerial module that includes an initialization module that is configured to enable managerial personnel to input information into the system that includes at least assigning specific persons to corresponding ones of said projects and tasks to be performed on said system. It may further included a departure detecting module that is configured to detect a current PID that has become distanced from the location of a given work station and to conclude that the person currently working on a task at that work station has ceased working on the project, but only when said departure has been detected over a predetermined time period. The departure module is further configured to automatically conclude tracking of time for a given task after a set number of hours has elapsed, regardless of whether a person has distanced themselves from said work station.

Preferably, there may be included an override module that enables a person to interact with the work station and to indicate that the person has not in fact left the work station and to continue tracking time on the given selected task. Also may be included is a task changing software module that enables a person to inform the work station that the person has opted to conclude working on the given task and to select another task for time tracking.

Preferably included is a priority module that is configured to alert persons about various tasks that they have been assigned to based-on priority criteria. Also may be included is a remote logging software module that enables persons associated with tasks to remotely log-on said work station and to enable tracking of time on selected tasks based on an analysis of keyboard operations being performed at a remote location by said person. Preferably, the managerial module is configured to enable managerial personnel to actively monitor the status of said tasks, including the amount of time that has already been invested on the different projects and tasks and to determine whether any projects are being carried out in adherence to budgeted time and cost criteria. The system may include one or more server computers and said plurality of work stations communicating with said server computer. The server(s) may be cloud based instead of being dedicated hardware uniquely associated with the system of the present invention.

In a preferred embodiment the invention comprises a time, activity and personnel tracking (TAPT) system, comprising: a plurality of work stations, each configured to perform thereat a plurality of tasks respectively associated with one or more of a plurality of projects, said tasks being associated with and assigned to be performed by one or more persons; a camera system and associated software that is configured to recognize a face of a person located at a computer and to match that face to only one of a plurality of faces stored in a database associated with said system, thereby to recognize and identify a person located at said work station; a task/project electronic recording (TR) board displayable at said work stations and configured to present said persons with a list of tasks assigned to said person, for selection by said person of a task to be performed; and a time tracking (TT) software module configured to track and record the amounts of time spent by said person on said selected task while at said work station. Preferably, the system includes a log-on software module that is configured to enable a person to log-on a selected one of said work stations by one of operating a keyboard on said work station and by pressing an icon on a screen associated with said work station.

Other features and advantages of the present invention will become apparent from the following description of the invention which refers to the accompanying drawings.

### BRIEF DESCRIPTION OF THE DRAWINGS

FIG. 1 illustrates a screen on a desktop or laptop computer that is utilized in a preferred embodiment of the invention.

FIG. 1A illustrates a stand-alone device that is used instead of the screen of FIG. 1.

FIG. 2 is a block diagram of a system layout of the present invention.

FIG. 3 is an illustration of a laptop or desktop computer screen and keyboard utilized with the present invention.

FIG. 4 is a flowchart of major components of software algorithms and modules utilized with the present invention.

### DETAILED DESCRIPTION OF EMBODIMENTS OF THE INVENTION

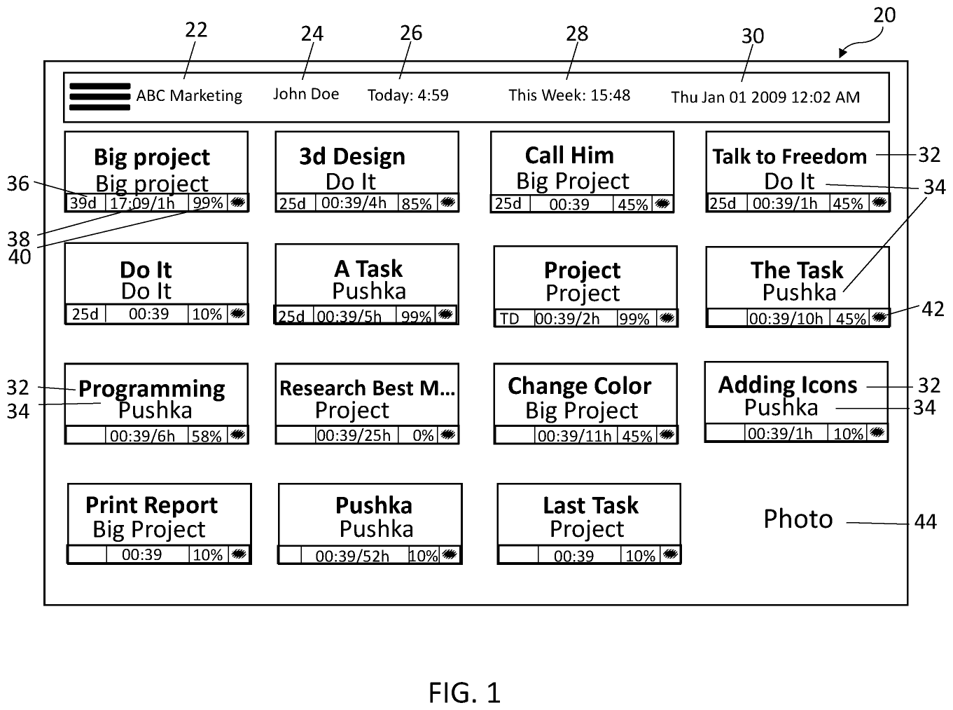

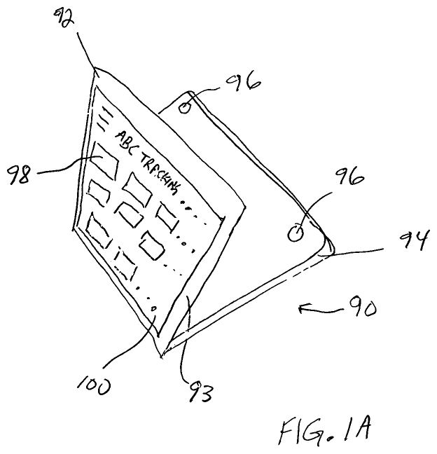

With reference to the drawings, commencing with FIG. 1, on the screen 20, along the top edge thereof may be indicated the name of the entity 22 for which the project is being performed, for example, ABC marketing. The name of the person performing the task, for example, John Doe 24 is also illustrated along with the time 26 and the cumulative hours spent on a particular week indicator 28 and a today's date 30.

The entry “Do It” or the entry “Pushka” 34 designates a particular project being worked on which is identified by the name of the project. The reference numeral 32 generally indicates the “task” that is being performed for a particular project, for example, “Talk to Freedom” or “Adding Icons,” etc.

Below the task 32 and the project 34 appears additional information, for example, the total hours allocated to the particular project which is indicated by reference numeral 36, the hours already spent which is indicated at 38 and a percentage 40 indicating the percentage of the allocated budget that has already been utilized.

Preferably, at the location PHOTO 44 may appear a photograph of the person who is currently utilizing the screen 20, and relative to whom the information is being collected and displayed. This aids a manager who may pass by and note whether the person sitting at a particular desktop or the like is in fact the person whose photo appears on the screen.

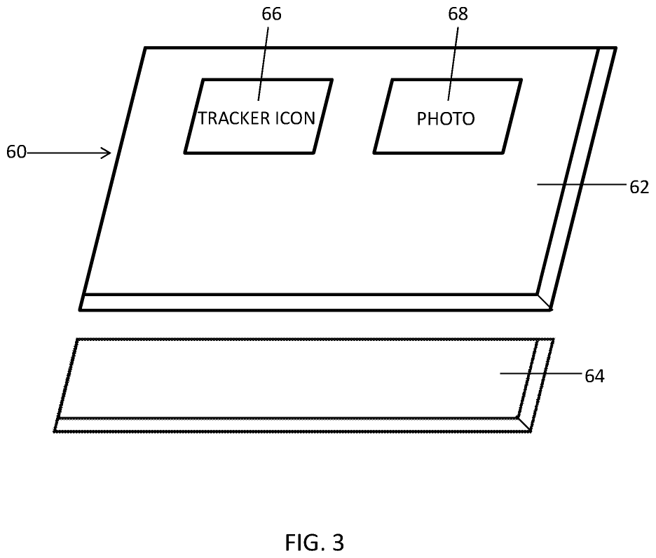

FIG. 1A shows an alternative to the screen 20 which is part of a work station where an employee performs his or her work. Instead, a separate screen 100 is provided as a stand-alone device 90 that has a display 93 that is supported vertically by a horizontally extending base 94 that incorporated holes 96 through which screws or a chain (not shown) can be passed to secure the device 90 directly to or to the general location of the work station 60 shown in FIG. 3. In other respects, the device 90 handles the information 98 and provides the functionality and purpose of the screen 20 and the information displayed thereon.

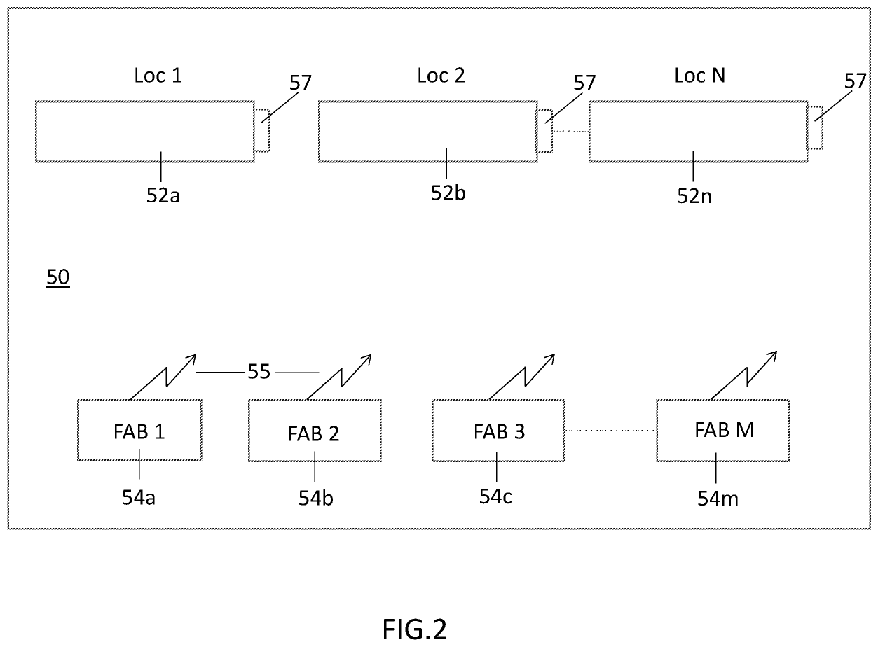

Turning to FIG. 2, in a typical application of the invention, there may be a plurality of locations including a first, second and an “n” location indicated by reference numerals 52a, 52b . . . 52n, which are the locations where the work station on which the screen 20 is located at different locations within an organization. It is assumed that particular people or employees will be assigned to the different locations, but this does not necessarily have to be so limited.

Regardless, individuals who are called upon to carry out the various tasks may bear on their body a FAB device, for example, any one of the FABs 54a, 54b, 54c . . . 54m and the arrows 55 indicate that these FABs 54 may communicate with sensors 57 at each location, which may operate by Near Frequency Communications (NFC), Bluetooth or the like to indicate the presence of the personnel carrying the FAB near the work station. This is similar to key FABs used with automobiles. Alternatively, these FABs are referred to herein as PIDs (Personal Identification Device). This has the dual benefit of sensing when an employee arrives near a location and is in fact identified by the location computer as a person who is involved with some project that is to be carried out, whereby the proximity of the person or the departure of the person can be sensed by the work station automatically. The sensor 57 can be of the type that senses the presence of the FAB. Alternatively, the sensor 57 is of a type that senses a human standing or sitting adjacent the work station. Or, the sensor 57 may be a camera system with related software that recognizes the face of the person at the computer and matches it to face information stored in a database. Alternatively, each person may log into the software application by pressing an icon on the screen, etc. Again, as noted above, the sensors may be located in the stand-alone device 90, which is located near the work station, instead of being integrated into the work stations (where the user's assignments are being performed in some invention embodiments).

FIG. 3 shows a typical tablet or desktop or laptop station 60 on which, at 66, may be located the icon of the present software which if touched may bring up the screen that is shown in FIG. 1 and the like. Also, the photo 44 in FIG. 1 may be placed at the location 68. Thereby while a person is utilizing the screen 62 and the keyboard 64, the program would track this situation and lock time on the particular project and task being performed.

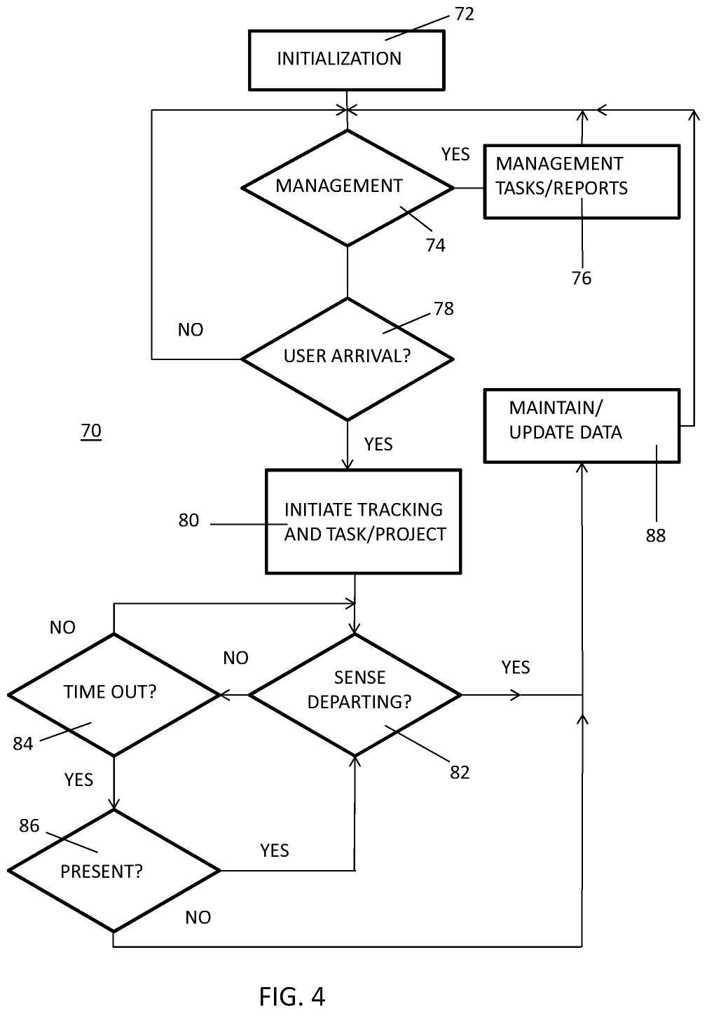

Turning now to the flowchart of FIG. 4, the underlying system and method of the present invention, which is software driven, utilizes various software modules including, as part of the overall system 70, an initialization module 72 which initializes the software in accordance with set criteria or various conditions as the case may be. Typically, once the software 70 is launched, it proceeds to a management decision block 74 which queries whether anyone has accessed the system in a management capacity. If yes, the software proceeds to the management tasks management report module 76 in which management can input into the overall system 70 the names of projects and tasks and other parameters mentioned above for the system including optionally the names of employees that will be associated with this project and whose time is to be tracked.

If, however, there is no management call on the system, the decision box 74 proceeds to the decision block 78 in which the software is inquires whether a user has either touched the icon on the screen of the work station or has been sensed to have arrived near the particular location, as mentioned above.

Once arrival of an authorized/registered user has been initiated, then the software module 80 initiates tracking of the particular task and project including commencing the clock on the particular project/task and attending to other tasks related thereto.

All the while, the program continues sensing whether the employee has departed at decisional blocks 82. This departure event can be sensed by the FAB distancing itself from the location of the particular work station or by the worker pressing an icon button on the screen of the computer. Assuming that the “departure” has been detected, the program proceeds to the module 88 where all the software parameters information is maintained and updated so that the data to management will reflect the correct and latest information. If however, no employee departures have been detected, the program proceeds to the time out decisional block 84 and asks whether a maximum time allowed at the work station has been exceeded. For example, the maximum time can be a set time, for example, five hours, eight hours or an amount of time that it is estimated would cause the employee to no longer be sitting at the station (but has nonetheless left the FAB nearby). This prevents employees departing, but leaving behind their FABs. If the timeout has not been reached, then the software returns to the decisional module 84. If, however, the timeout has been exceeded, the program can proceed to the module 86 and thereat issue a query on the screen asking the user to press a button to indicate physically that the person is still there. Alternatively, a sensor can be utilized to sense whether the employee is sitting near the work station location 52. If the employee is still present, then the software returns to the data maintenance and updating module 88.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A time, activity and personnel tracking (TAPT) system, comprising:
a plurality of work stations, each configured to perform thereat a plurality of tasks respectively associated with one or more of a plurality of projects, said tasks being associated with and assigned to be performed by one or more persons;
a plurality of personal identification devices (PID) configured to be worn or carried by said persons and each said PID uniquely identifying a respective one of said persons;
a plurality of proximity sensors (PXS), each said PXS being mounted to or located near a respective one of said work stations, and being configured to detect the presence of a given one of said persons adjacent thereto, by sensing the PID worn or carried by that person, when said given person has located himself or herself within a predetermined distance to said PXS;
a task/project electronic recording (TR) board displayable at a display associated with said work stations and configured to present said persons with a list of tasks assigned to said person, for selection by said person of a task to be performed; and
a time tracking (TT) software module configured to track and record the amounts of time spent by said person on said selected task.

2. The TAPT system of claim 1, said TR board being further configured to display to said person a total hours parameter that designates a total number of hours that has been allocated to said tasks.

3. The TAPT system of claim 1, said TR board being further configured to display to said person a total hours spent parameter that designates the number of hours already spent by said person on said task.

4. The TAPT system of claim 1, said TR board being further configured to display to said person a total hours percentage parameter that designates a percentage of an allocated budget that has already been utilized on a given project.

5. The TAPT system of claim 1, wherein said PID is configured to be detected by said PXS utilizing one of near frequency communications (NFC) and Bluetooth.

6. The TAPT system of claim 1, wherein said TR board is located on a stand-alone display device located adjacent a respective work station associated with a respective one of said users.

7. The TAPT system of claim 1, further including a camera system and associated software that is configured to recognize a face of a person located at a computer and to match that face to only one of a plurality of faces stored in a database associated with said system, thereby to recognize and identify a person located at said work station.

8. The TAPT system of claim 1, further including a log-on software module that is configured to enable a person to log-on a selected one of said work stations by one of operating a keyboard on said work station and by pressing an icon on a screen associated with said work station.

9. The TAPT system of claim 1, further including a managerial module that includes an initialization module that is configured to enable managerial personnel to input information into the system that includes at least assigning specific persons to corresponding ones of said projects and tasks to be performed on said system.

10. The TAPT system of claim 1, further including a departure detecting module that is configured to detect a current PID that has become distanced from the location of a given work station and to conclude that the person currently working on a task at that work station has ceased working on the project, but only when said departure has been detected over a predetermined time period.

11. The TAPT system of claim 10, wherein said departure module is further configured to automatically conclude tracking of time for a given task after a set number of hours has elapsed, regardless of whether a person has distanced themselves from said work station.

12. The TAPT system of claim 11, including an override module that enables a person to interact with the work station and to indicate that the person has not in fact left the work station and to continue tracking time on the given selected task.

13. The TAPT system of claim 1, further including a task changing software module that enables a person to inform the work station that the person has opted to conclude working on the given task and to select another task for time tracking.

14. The TAPT system of claim 1, further including a priority module that is configured to alert persons about various tasks that they have been assigned to said persons based on priority criteria.

15. The TAPT system of claim 1, further including a remote logging software module that enables persons associated with tasks to remotely log-on said work station and to enable tracking of time on selected tasks based on an analysis of keyboard operations being performed at a remote location by said person.

16. The TAPT system of claim 9, wherein the managerial module is configured to enable managerial personnel to actively monitor the status of said tasks, including the amount of time that has already been invested on the different projects and tasks and to determine whether any projects are being carried out in adherence to budgeted time and cost criteria.

17. The TAPT system of claim 1, further including at least one server computer and said plurality of work stations communicating with said server computer.

18. A time, activity and personnel tracking (TAPT) system, comprising:
a plurality of work stations, each configured to perform thereat a plurality of tasks respectively associated with one or more of a plurality of projects, said tasks being associated with and assigned to be performed by one or more persons;
a camera system and associated software that is configured to recognize a face of a person located at a computer and to match that face to only one of a plurality of faces stored in a database associated with said system, thereby to recognize and identify a person located at said work station;
a task/project electronic recording (TR) board displayable at or near said work stations and configured to present said persons with a list of tasks assigned to said person, for selection by said person of a task to be performed; and
a time tracking (TT) software module configured to track and record the amounts of time spent by said person on said selected task while at said work station.

19. The TAPT system of claim 18, further including a log-on software module that is configured to enable a person to log-on a selected one of said work stations by one of operating a keyboard on said work station and by pressing an icon on a screen associated with said work station.

20. The TAPT system of claim 18, wherein the TR board is located on a stand-alone device that is located adjacent said work station.
